(19) United States
(12) Patent Application Publication
(10) Pub. No.: US 2022/0356633 A1
(43) Pub. Date: Nov. 10, 2022

(54) DEBRIS COLLECTION APPARATUS

(71) Applicant: WHIRLPOOL CORPORATION, BENTON HARBOR, MI (US)

(72) Inventor: Sayer James Murphy, St. Joseph, MI (US)

(73) Assignee: WHIRLPOOL CORPORATION, BENTON HARBOR, MI (US)

(21) Appl. No.: 17/734,502

(22) Filed: May 2, 2022

Related U.S. Application Data
(60) Provisional application No. 63/183,798, filed on May 4, 2021.

(51) Int. Cl. D06F 58/22; B01D 46/681; B01D 46/00; B01D 46/42

(52) U.S. Cl. CPC D06F 58/22; B01D 46/681; B01D 46/0043; B01D 46/4272; B01D 2273/30; B01D 2279/55

(57) ABSTRACT

A debris collection apparatus includes a blower assembly and a collection assembly. The collection assembly defines an upper aperture, a lower aperture, and a hollow structure extending between the upper and lower apertures. A wiper is positioned within the hollow structure. A flapper valve is coupled to the lower aperture. A filter is coupled to an inner surface of the hollow structure.

### CROSS-REFERENCE TO RELATED APPLICATION

This application claims priority to U.S. Provisional Patent Application No. 63/183,798, filed on May 4, 2021, entitled “DEBRIS COLLECTION APPARATUS,” the disclosure to which is hereby incorporated herein by reference in its entirety.

### FIELD OF THE DEVICE

The present device relates to a laundering appliance. More specifically, the present device relates to a debris collection apparatus.

### BRIEF SUMMARY OF THE DEVICE

According to a first aspect of the present disclosure, a debris collection apparatus includes a blower assembly and a collection assembly. The collection assembly defines an upper aperture, a lower aperture, and a hollow structure extending between the upper aperture and the lower aperture. A wiper is positioned within the hollow structure. A flapper valve is coupled to the lower aperture. The flapper valve is movable between an open position and a closed position relative to the lower aperture. A filter is coupled to an inner surface of the hollow structure.

According to another aspect of the present disclosure, a debris collection apparatus includes a blower assembly and a collection assembly. The collection assembly defines an upper aperture, a lower aperture, and a hollow structure. The hollow structure extends between the upper aperture and the lower aperture. A conduit couples the blower assembly to the collection assembly. Operation of the blower assembly generates a negative pressure within the collection assembly. A wiper is positioned within the hollow structure. A flapper valve is coupled to the lower aperture. The flapper valve is movable between an open position and a closed position relative to the lower aperture. The negative pressure generated within the collection assembly by the blower assembly actuates the flapper valve to the closed position. A filter is coupled to an inner surface of the hollow structure. A bulk debris collection vessel is positioned below the lower aperture.

### BRIEF DESCRIPTION OF THE DRAWINGS

In the drawings:

FIG. 1 is a front perspective view of a laundering appliance, illustrating a debris collection apparatus thereof, according to one example;

FIG. 2 is a rear perspective view of the debris collection apparatus of FIG. 1, illustrating a flapper valve in an open position;

FIG. 3 is a rear perspective view of the debris collection apparatus of FIG. 2, illustrating the flapper valve in a closed position;

FIG. 4 is a bottom perspective view of the debris collection apparatus of FIG. 2;

FIG. 5 is a side perspective view of the debris collection apparatus of FIG. 2;

FIG. 6 is a front perspective view of the debris collection apparatus, illustrating the flapper valve in the open position, according to another example;

FIG. 7 is a front perspective view of the debris collection apparatus of FIG. 6, illustrating the flapper valve in the closed position; and

FIG. 8 is a schematic view of the laundering appliance, illustrating a controller with various inputs, according to one example.

### DETAILED DESCRIPTION

The present illustrated embodiments reside primarily in combinations of method steps and apparatus components related to a cooking appliance door push button assembly. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

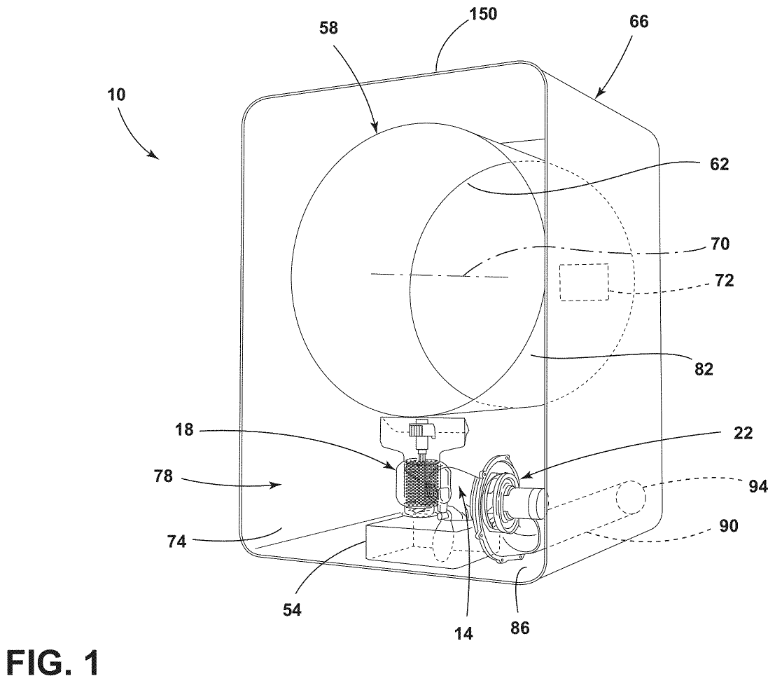

For purposes of description herein, the terms “upper,” “lower,” “right,” “left,” “rear,” “front,” “vertical,” “horizontal,” and derivatives thereof shall relate to the disclosure as oriented in FIG. 1. Unless stated otherwise, the term “front” shall refer to the surface of the element closer to an intended viewer, and the term “rear” shall refer to the surface of the element further from the intended viewer. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises a . . . ” does not, without more constraints, preclude the existence of additional identical elements in the process, method, article, or apparatus that comprises the element.

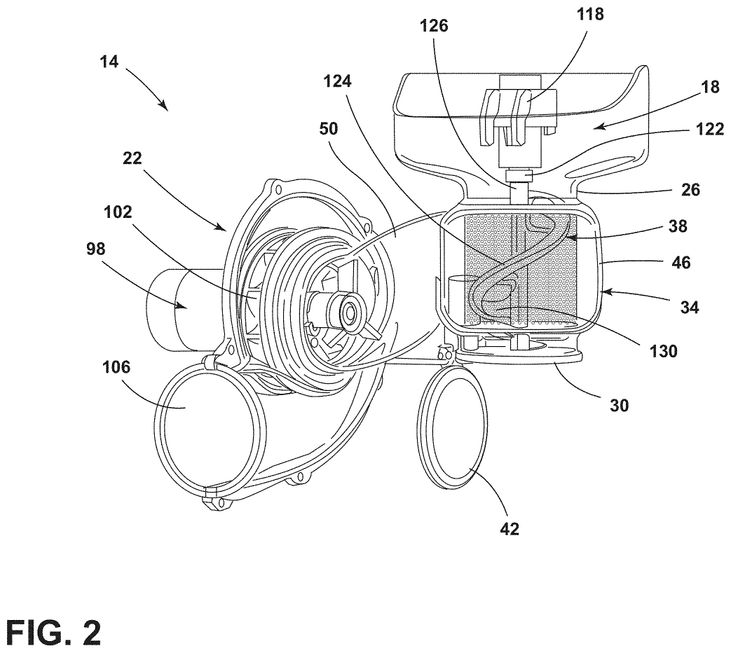

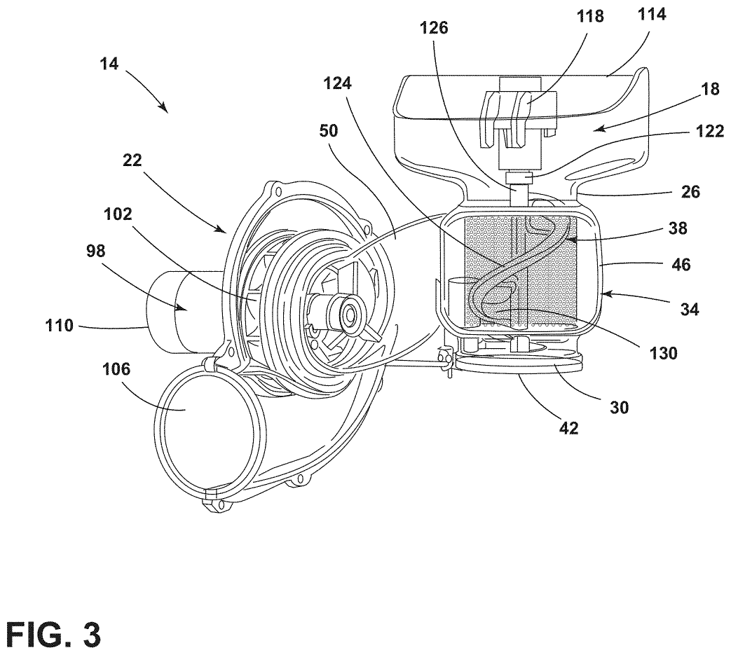

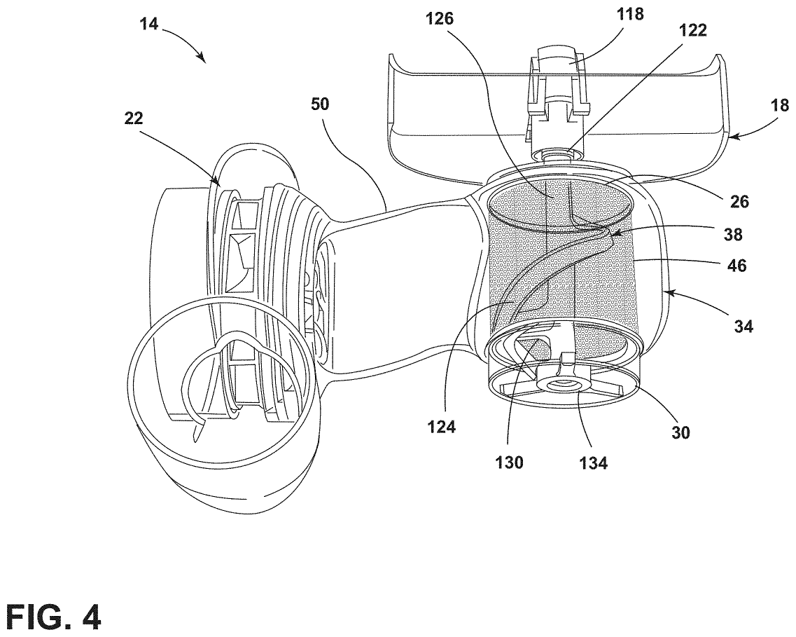

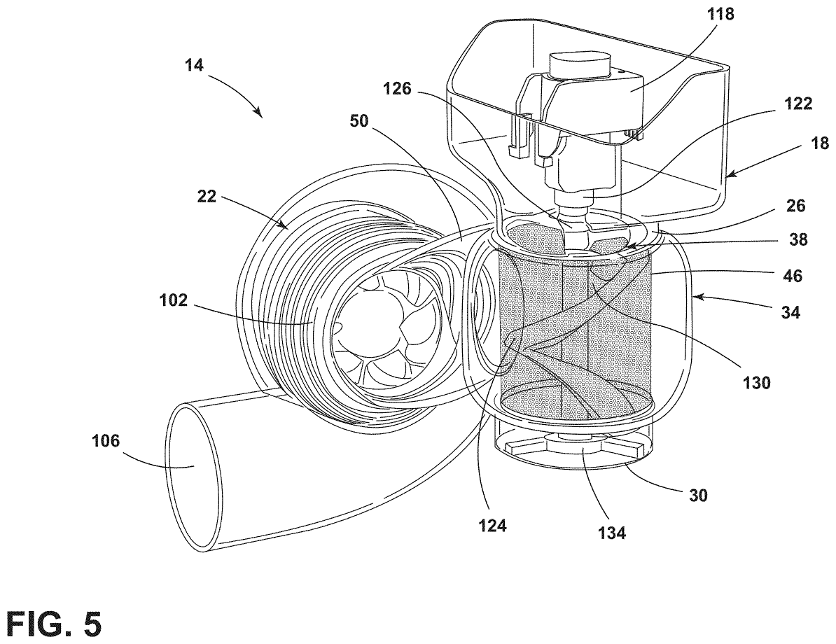

With respect to FIGS. 1-7, a laundering appliance 10 includes a debris collection apparatus 14. The debris collection apparatus 14 includes a collection assembly 18 and a blower assembly 22. The collection assembly 18 defines an upper aperture 26, a lower aperture 30, and a hollow structure 34. The hollow structure 34 extends between the upper and lower apertures 26, 30. A wiper 38 is positioned within the hollow structure 34. A flapper valve 42 is coupled to the lower aperture 30. A filter 46 is coupled to an interior of the hollow structure 34. The blower assembly 22 can be horizontally offset from the collection assembly 18. The collection assembly 18 and the blower assembly 22 are coupled by a conduit 50 such that operation of the blower assembly 22 generates a negative pressure within the collection assembly 18. The negative pressure generated by the blower assembly 22 actuates the flapper valve 42 from an open position to a closed position. Accordingly, it may be beneficial for the flapper valve 42 to be made from a relatively lightweight material (e.g., a polymer) in an effort to decrease a resistance to actuation by the negative pressure. Similarly, the dimensions and positioning of the flapper valve 42 can be chosen to encourage actuation by the negative pressure. A bulk debris collection vessel 54 is positioned below the lower aperture 30. In some examples, the wiper 38 may be a helical wiper. In other examples, the wiper 38 may be a linear or planar collection device, such as a planar wiper that oscillates or reciprocates.

The laundering appliance 10 includes a drum 58 that defines a cavity 62. The drum 58 is suspended within a body 66 of the laundering appliance 10. The body 66 may at least partially define the cavity 62. The drum 58 receives articles to be laundered (e.g., clothing) and is rotatable about a horizontal axis 70 or an angled rotational axis. As the laundering appliance 10 rotates the drum 58, air is provided to the cavity 62 of the drum 58. The air that is provided to the cavity 62 can be employed to dry and/or freshen the articles placed within the drum 58. In various operating modes, the air provided to the cavity 62 may be heated by a heating device 72 provided in the laundering appliance 10. During the various operating modes, lint or other debris may be dislodged or dissociated with the articles that are contained within the drum 58. The negative pressure or suction provided to the debris collection apparatus 14 by the blower assembly 22 can draw the dislodged or dissociated debris into the debris collection apparatus 14 and be removed from the cavity 62. The drum 58 may be provided with one or more perforations that can aid in allowing air to be introduced into the cavity 62 and/or the debris to exit the cavity 62. The body 66 may also include openings or apertures that assist in directing air through the perforations of the drum 58 and toward the debris collection apparatus 14. Ductwork can extend between a region proximate to the one or more perforations and the upper aperture 26 to direct the debris to the debris collection apparatus 14. In the depicted example, the debris collection apparatus 14 is positioned in a void 74 that is proximate to a lower region 78 of the laundering appliance 10. The void 74 is typically defined by an exterior surface 82 of the drum 58 and an interior surface 86 of the body 66.

Referring again to FIGS. 1-7, the debris collection apparatus 14 includes an exhaust conduit 90 that extends from an outlet 106 of the blower assembly 22 to an exhaust aperture 94 that is defined by the body 66. The exhaust conduit 90 and the exhaust aperture 94 serve to direct air that is pulled from the cavity by the blower assembly 22 toward an environment that is exterior to the laundering appliance 10. The blower assembly 22 includes a blower motor 98 that is positioned opposite to the conduit 50. The blower motor 98 powers a fan wheel 102 to rotate. The fan wheel 102 is in fluid communication with the debris collection apparatus 14 by way of the conduit 50. As the fan wheel 102 is driven to rotate by the blower motor 98, an air flow is induced out of an outlet 106 of the blower assembly 22 and toward the exhaust aperture 94. This induced air flow creates a negative pressure within the debris collection apparatus 14 and causes the flapper valve 42 to actuate to a closed position. A free end 110 of the blower motor 98 can be employed in mounting or positioning the debris collection apparatus 14 within the body 66.

Referring further to FIGS. 1-7, the flapper valve 42 is hingedly coupled to a side of the hollow structure 34 such that a rotational axis of the flapper valve 42 is proximate to the lower aperture 30. The debris collection apparatus 14 can include a receptacle 114 that extends upwardly and/or outwardly away from the upper aperture 26. Accordingly, the receptacle 114 may act as a funnel to direct the debris from the cavity 62 toward the hollow structure 34, which contains the filter 46. In operation, when the blower motor 98 is activated, air is accelerated out of the outlet 106. As air is forced out of the outlet 106, the negative pressure is established by pulling air out of the conduit 50, which in turn pulls air out of the collection assembly 18. Pulling air out of the collection assembly 18 generates a suction within the hollow structure that causes the flapper valve 42 to close and contemporaneously draws air and particulate matter from the cavity 62 within the drum 58. The negative pressure is maintained while the blower motor 98 is activated and the flapper valve 42 is closed. The negative pressure within the collection assembly 18 draws air out of the cavity 62 defined by the drum 58, thereby providing a suction force for the removal and capture of debris. The receptacle 114 can funnel the debris toward the filter 46.

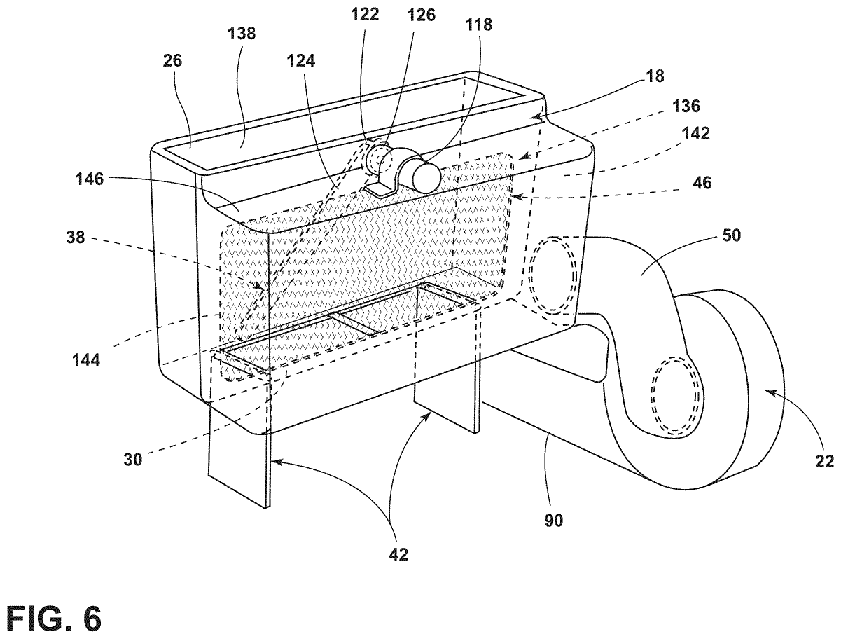

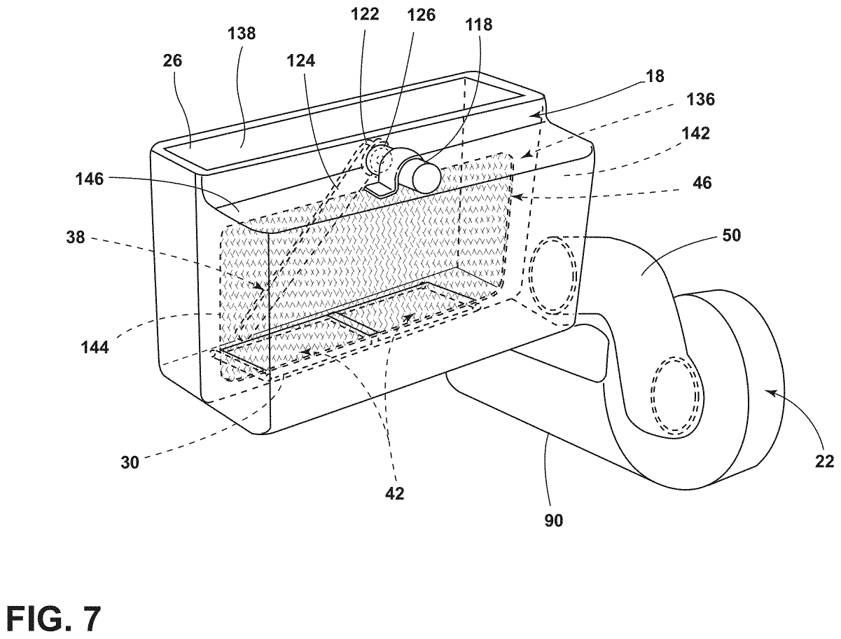

In the example depicted in FIGS. 1-5, a wiper motor 118 is positioned within the receptacle 114 and coupled to an upper end 122 of the wiper 38. In the example depicted in FIGS. 6-7, the wiper motor 118 may be coupled to the hollow structure 34 and extend through a wall thereof. In such examples, the wiper motor 118 may couple to the upper end 122 of the wiper 38 proximate to the upper aperture 26. Regardless of the arrangement of the wiper motor 118, the wiper motor 118 drives the wiper 38 to actuate in a manner that wipes or otherwise dislodges debris that has been captured by the filter 46.

With specific reference to FIGS. 1-5, the wiper 38 is typically in the form of a helical wiper and includes a wiper arm 124 that extends from or wraps around a driveshaft 126. The wiper arm 124 contacts an interior surface, or an interior perimeter, of the filter 46. The driveshaft 126 extends from the wiper motor 118 and into the hollow structure 34. Support arms 130 extend between the wiper arm 124 and the driveshaft 126. The driveshaft 126 can be received by a support structure 134 positioned proximate to the lower aperture 30. The support structure 134 can aid in positioning and/or supporting the driveshaft 126.

In various examples, the wiper motor 118 can be mounted to the collection assembly 18 in a manner that maintains the wiper motor 118 stationary and provides a surface upon which forces that oppose the rotation of the driveshaft 126 may act. Such an arrangement can ensure rotational motion provided by the wiper motor 118 is transmitted to the driveshaft 126 rather than causing the wiper motor 118 to rotate about the driveshaft 126. As the wiper motor 118 drives the driveshaft 126 to rotate, the wiper arm 124 is adjusted in its position relative to the filter 46. The rotation of the wiper 38 by the wiper motor 118 may be unidirectional, with the unidirectional rotation corresponding with the wiper arm 124 driving debris in a downward direction (i.e., toward the lower aperture 30) as a result of the unidirectional rotation. For example, when viewed from the position of the wiper motor 118, the wiper motor 118 may drive the driveshaft 126 in a counterclockwise direction in a unidirectional manner, thereby sweeping debris from the filter 46 for deposition into the bulk debris collection vessel 54. The helical shape of the wiper produces a screw-type motion that directs the captured lint particles toward the bulk debris collection vessel 54.

Referring now to FIGS. 1, 6, and 7, the wiper 38 can be in the form of a planar wiper and includes the wiper arm 124 and the driveshaft 126. The wiper arm 124 contacts the interior surface of the filter 46. The driveshaft 126 extends laterally between the wiper arm 124 and the wiper motor 118. The wiper arm 124 extends downwardly into the hollow structure 34 to contact the filter 46. In various examples, the wiper motor 118 can be mounted to the collection assembly 18 in a manner that maintains the wiper motor 118 stationary and provides a surface upon which forces that oppose the rotation of the driveshaft 126 may act. Such an arrangement can ensure rotational motion provided by the wiper motor 118 is transmitted to the driveshaft 126 rather than causing the wiper motor 118 to rotate about the driveshaft 126. As the wiper motor 118 drives the driveshaft 126 to rotate, the wiper arm 124 is adjusted in its position relative to the filter 46.

In the depicted example, the wiper motor 118 typically provides a bidirectional movement of the wiper arm 124 relative to the filter 46 such that the wiper arm 124 sweeps back-and-forth across the filter 46. Such motion of the wiper arm 124 can act to dislodge debris that has been captured by the filter 46 and thereby result in the deposition of the debris into the bulk debris collection vessel 54. In some examples, the wiper arm 124 may be provided with bristles that extend from a surface thereof to contact the filter 46. In such an example, the wiper arm 124 may alternatively be referred to as a brush.

With specific reference to FIGS. 6-7, the hollow structure 34 of the collection assembly 18 can define a first chamber 138 and a second chamber 142. The first chamber 138 and the second chamber 142 can be separated by a partition wall 136. The partition wall 136 defines an aperture 144. The first chamber 138 and the second chamber 142 can be separated by the filter 46. The filter 46 can be directly coupled to the partition wall 144 in a manner that positions the filter 46 over the aperture 144. The first chamber 138 extends between the upper and lower apertures 26, 30. The wiper arm 124 is positioned within the first chamber 138. The second chamber 142 is directly coupled to the conduit 50 that extends to the blower assembly 22. In operation, air is pulled into the first chamber 138, through the filter 46, and into the second chamber 142 as a result of activation of the blower assembly 22 (e.g., the blower motor 98). An upper wall 146 of the second chamber 142 may provide the support surface to which the wiper motor 118 is mounted. The driveshaft 126 can extend through the partition wall 136.

Referring again to FIGS. 6-7, the flapper valve 42 can be a pair of opposing doors. Similar to the configuration discussed with regard to FIGS. 1-5, air travels from the cavity 62 of the drum 58 and into the hollow structure 34. Within the hollow structure 34, the air from the cavity 62 is received by the first chamber 138, directed through the filter 46, and then received in the second chamber 142. The air within the second chamber 142, which likely has a decreased debris content, is drawn into the conduit 50 and directed out the exhaust conduit 90. The bulk debris collection vessel 54 is positioned below the first chamber 138.

According to various examples of the present disclosure, the filter 46 can define a lattice structure that is arranged with a predetermined pore size or lattice density. The predetermined pore size or lattice density can be designed to capture particulate matter above a certain particle size. In some examples, the filter 46 may be of a wire mesh construction. Regardless of the material or arrangement of the filter 46, the filter 46 may be permanently fixed within the collection assembly 18. Said another way, the filter 46 may not be removable from the collection assembly 18 and/or the laundering appliance 10. A benefit of the present disclosure lies in an ease-of-use for a consumer. In particular, the debris collection apparatus' 14 discussed herein can be emptied of the debris collected therein with longer intervals between sequential emptying of the bulk debris collection vessel 54 than in laundering appliances 10 that do not employ the debris collection apparatus' 14 discussed herein. In various examples, the bulk debris collection vessel 54 can be a drawer or other suitable container that can be accessed from an exterior of the laundering appliance 10 for periodic disposal of accumulated debris deposits. By placing the debris collection apparatus 14 within the lower region 78 of the laundering appliance 10, debris can be prevented from being dislodged from the filter 46 and deposited onto an upper surface 150 of the body 66 during removal of debris, which can occur with alternative arrangements of laundering appliances. The bulk debris collection vessel 54 may be emptied after every cycle of operation (e.g., every drying cycle) of the laundering appliance 10 or after a plurality of cycles of operation (e.g., two, five, ten, or more cycles of operation).

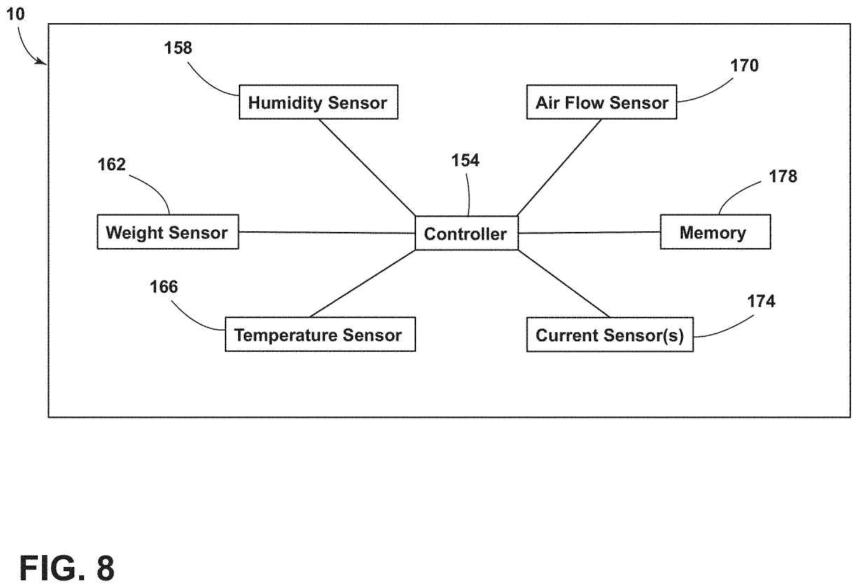

Referring to FIGS. 1-8, in various examples, the wiper 38 may be driven to actuate (e.g., by a controller 154) during an operating cycle of the laundering appliance 10 (e.g., a drying cycle). Alternatively, the wiper 38 may be driven to actuate before execution of the operating cycle, after execution of the operating cycle, and/or after a predetermined number of operating cycles. The predetermined number of operating cycles may be determined by counting the number of operating cycles that have elapsed since the wiper 38 was last actuated. Alternatively, the predetermined number of operating cycles may be determined based upon an operating efficiency of the laundering appliance 10. The operating efficiency of the laundering appliance 10 may be determined by the controller 154 referencing a humidity sensor 158 that senses a humidity within the cavity 62, the controller 154 referencing a weight of the articles within the cavity 62 with a weight sensor 162 that is coupled to the drum 58 (e.g., beginning weight and current weight), the controller 154 referencing a temperature sensor 166 that senses a temperature within the cavity 62, and/or the controller 154 referencing an air flow rate with an air flow sensor 170. The operating efficiency may also be determined by current sensors 174 that measure the electrical current that is drawn by various electrical components. Other sensor types are contemplated as well as sensor configurations to assess a baseline efficiency as well as a current operating efficiency.

The various referenced measurements that are captured and/or recorded using the sensors can be compared to stored measurements (e.g., by the controller 154 referencing a memory 178). The stored measurements may be measurements that were stored within the appliance during manufacture, obtained when the cavity 62 was devoid of articles and/or measurements that were obtained at the beginning of the operating cycle. Regardless of the trigger used to actuate the wiper 38, the wiper 38 can dislodge debris that has been captured by the filter 46 in an effort to improve the operating efficiency of the laundering appliance 10. Debris that has been dislodged by the wiper 38 and/or captured by the hollow structure 34 can be deposited into the bulk debris collection vessel 54 once the blower motor 98 has been turned off or is no longer energized. When the blower assembly 22 is no longer operating, the negative pressure provided by the operation of the blower assembly 22 lessens or ceases and the flapper valve 42 can be actuated to an open position by gravity or a flapper motor.

In the various configurations discussed herein, the wiper 38 can be operated to dislodge debris captured by the filter 46 once the blower motor 98 has been disengaged and the flapper valve 42 has been placed in the open position. Accordingly, the dislodged debris can fall directly into the bulk debris collection vessel 54 from the filter 46. It is contemplated that the wiper 38 may be operated while the blower motor 98 is engaged such that debris dislodged from the filter 46 may accumulate on the closed flapper valve 42. In such an example, the dislodged debris is deposited from the flapper valve 42 into the bulk debris collection vessel 54 once the blower motor 98 is disengaged. It is also contemplated that the controller 154 may disengage the blower motor 98 if the controller 154 determines that debris has accumulated on the filter 46 to an extent that an operating efficiency of the laundering appliance 10 may benefit from dislodging the debris. For example, one of the current sensors 174 may sense an increase in a current drawn by the blower motor 98 and thereby indicate to the controller 154 that the blower motor 98 may be experiencing a resistance to air flow. In such a situation, the controller 154 may disengage the blower motor 98 and operate the wiper 38. With the negative pressure decreased, either by decreased air flow as a result of debris accumulation or disengagement of the blower motor 98, the flapper valve 42 is placed in the open position or dislodged debris can be deposited into the bulk debris collection vessel 54.

It is contemplated that the various configurations discussed above can be altered or combined. For example, the wiper 38 can direct debris laterally or at an angle. However, it may be beneficial to arrange the upper aperture 26 vertically above the lower aperture 30. In such an example, operation of the wiper 38 may dislodge debris from the hollow structure 34 and/or the filter 46 in a manner that causes the dislodged debris to fall immediately toward the flapper valve 42 such that the dislodged debris can be deposited into the bulk debris collection vessel 54. It is also contemplated that airflow can move in alternative manners than the configurations shown, depending upon the positioning of air inlet(s) and the outlet 106.

According to a first aspect of the present disclosure, a debris collection apparatus includes a blower assembly and a collection assembly. The collection assembly defines an upper aperture, a lower aperture, and a hollow structure extending between the upper aperture and the lower aperture. A wiper is positioned within the hollow structure. A flapper valve is coupled to the lower aperture. The flapper valve is movable between an open position and a closed position relative to the lower aperture. A filter is coupled to an inner surface of the hollow structure.

According to another aspect, a debris collection apparatus is coupled to a laundering appliance. The laundering appliance includes a drum, a cavity defined by the drum, and a heating device that heats air that is provided to the cavity.

According to yet another aspect, a blower assembly and a collection assembly are coupled by a conduit.

According to another aspect, a blower assembly is horizontally offset from a collection assembly.

According to still another aspect, a blower assembly includes a blower motor positioned opposite a conduit, a fan wheel that is driven to rotate by the blower motor, and an outlet.

According to another aspect, a debris collection apparatus includes an exhaust conduit that extends from an outlet of a blower assembly.

According to yet another aspect, operation of a blower assembly generates a negative pressure within a collection assembly.

According to another aspect, a negative pressure generated within a collection assembly by a blower assembly actuates a flapper valve to a closed position.

According to still another aspect, a debris collection apparatus includes a bulk debris collection vessel that is positioned below a lower aperture.

According to another aspect, a wiper is operated by rotational motion.

According to yet another aspect, a wiper is a helical wiper.

According to another aspect, a wiper is operated in an oscillating fashion.

According to still another aspect, a wiper is a planar wiper.

According to another aspect, a debris collection apparatus includes a receptacle that extends upwardly away from an upper aperture.

According to yet another aspect, a debris collection apparatus includes a wiper motor positioned within a receptacle. The wiper motor drives movement of a wiper.

According to another aspect of the present disclosure, a debris collection apparatus, includes a blower assembly and a collection assembly. The collection assembly defines an upper aperture, a lower aperture, and a hollow structure. The hollow structure extends between the upper aperture and the lower aperture. A conduit couples the blower assembly to the collection assembly. Operation of the blower assembly generates a negative pressure within the collection assembly. A wiper is positioned within the hollow structure. A flapper valve is coupled to the lower aperture. The flapper valve is movable between an open position and a closed position relative to the lower aperture. The negative pressure generated within the collection assembly by the blower assembly actuates the flapper valve to the closed position. A filter is coupled to an inner surface of the hollow structure. A bulk debris collection vessel is positioned below the lower aperture.

According to still another aspect, a debris collection apparatus is coupled to a laundering appliance. The laundering appliance includes a drum, a cavity defined by the drum, and a heating device that heats air that is provided to the cavity.

According to another aspect, a blower assembly includes a blower motor positioned opposite a conduit, a fan wheel that is driven to rotate by the blower motor, and an outlet. The blower assembly is horizontally offset from a collection assembly.

According to yet another aspect, a wiper is a helical wiper or a planar wiper.

According to another aspect, a debris collection apparatus includes a receptacle that extends upwardly away from an upper aperture.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

What is claimed is:

1. A debris collection apparatus, comprising:
a blower assembly;
a collection assembly, wherein the collection assembly defines an upper aperture, a lower aperture, and a hollow structure extending between the upper aperture and the lower aperture;
a wiper positioned within the hollow structure;
a flapper valve coupled to the lower aperture, wherein the flapper valve is movable between an open position and a closed position relative to the lower aperture; and
a filter coupled to an inner surface of the hollow structure.

2. The debris collection apparatus of claim 1, wherein the debris collection apparatus is coupled to a laundering appliance, wherein the laundering appliance comprises:
a drum;
a cavity defined by the drum; and
a heating device that heats air that is provided to the cavity.

3. The debris collection apparatus of claim 1, wherein the blower assembly and the collection assembly are coupled by a conduit.

4. The debris collection apparatus of claim 3, wherein the blower assembly is horizontally offset from the collection assembly.

5. The debris collection apparatus of claim 3, wherein the blower assembly comprises:
a blower motor positioned opposite the conduit;
a fan wheel that is driven to rotate by the blower motor; and
an outlet.

6. The debris collection apparatus of claim 5, further comprising:
an exhaust conduit that extends from the outlet of the blower assembly.

7. The debris collection apparatus of claim 1, wherein operation of the blower assembly generates a negative pressure within the collection assembly.

8. The debris collection apparatus of claim 7, wherein the negative pressure generated within the collection assembly by the blower assembly actuates the flapper valve to the closed position.

9. The debris collection apparatus of claim 1, further comprising:
a bulk debris collection vessel positioned below the lower aperture.

10. The debris collection apparatus of claim 1, wherein the wiper is operated by rotational motion.

11. The debris collection apparatus of claim 10, wherein the wiper is a helical wiper.

12. The debris collection apparatus of claim 10, wherein the wiper is operated in an oscillating fashion.

13. The debris collection apparatus of claim 12, wherein the wiper is a planar wiper.

14. The debris collection apparatus of claim 1, further comprising:
a receptacle that extends upwardly away from the upper aperture.

15. The debris collection apparatus of claim 14, further comprising:
a wiper motor positioned within the receptacle, wherein the wiper motor drives movement of the wiper.

16. A debris collection apparatus, comprising:
a blower assembly;
a collection assembly, wherein the collection assembly defines an upper aperture, a lower aperture, and a hollow structure extending between the upper aperture and the lower aperture;
a conduit that couples the blower assembly to the collection assembly, wherein operation of the blower assembly generates a negative pressure within the collection assembly;
a wiper positioned within the hollow structure;
a flapper valve coupled to the lower aperture, wherein the flapper valve is movable between an open position and a closed position relative to the lower aperture, wherein the negative pressure generated within the collection assembly by the blower assembly actuates the flapper valve to the closed position;
a filter coupled to an inner surface of the hollow structure; and
a bulk debris collection vessel positioned below the lower aperture.

17. The debris collection apparatus of claim 16, wherein the debris collection apparatus is coupled to a laundering appliance, wherein the laundering appliance comprises:
a drum;
a cavity defined by the drum; and
a heating device that heats air that is provided to the cavity.

18. The debris collection apparatus of claim 16, wherein the blower assembly comprises:
a blower motor positioned opposite the conduit;
a fan wheel that is driven to rotate by the blower motor; and
an outlet, wherein the blower assembly is horizontally offset from the collection assembly.

19. The debris collection apparatus of claim 16, wherein the wiper is a helical wiper or a planar wiper.

20. The debris collection apparatus of claim 16, further comprising:
a receptacle that extends upwardly away from the upper aperture.
